(19) United States
(12) Patent Application Publication
(10) Pub. No.: US 2017/0161592 A1
(43) Pub. Date: Jun. 8, 2017

(54) SYSTEM AND METHOD FOR OBJECT DETECTION DATASET APPLICATION FOR DEEP-LEARNING ALGORITHM TRAINING

(71) Applicant: Pilot AI Labs, Inc., Sunnyvale, CA (US)

(72) Inventors: Jonathan Su, San Jose, CA (US); Ankit Kumar, San Diego, CA (US); Brian Pierce, Santa Clara, CA (US); Elliot English, Stanford, CA (US)

(73) Assignee: Pilot AI Labs, Inc., Sunnyvale, CA (US)

(21) Appl. No.: 15/369,748

(22) Filed: Dec. 5, 2016

Related U.S. Application Data
(60) Provisional application No. 62/263,606, filed on Dec. 4, 2015.

(51) Int. Cl. G06K 9/66; G06N 3/08; G06T 11/60; G06N 3/04; G06K 9/46; G06T 7/13

(52) U.S. Cl. CPC G06K 9/66; G06K 9/4604; G06T 7/13; G06T 11/60; G06N 3/04; G06N 3/08

(57) ABSTRACT

According to various embodiments, a method for neural network dataset enhancement is provided. The method comprises taking a first picture using a fixed camera of just a set background, then taking a second picture with the fixed camera. The second picture is taken with the set background and an object of interest in the picture frame. The method further comprises extracting pixels of the image of the object of interest from the second picture, and superimposing the pixels of the image of the object of interest onto a plurality of different images.

### CROSS REFERENCE TO RELATED APPLICATIONS

This application claims priority under 35 U.S.C. §119(e) to U.S. Provisional Application No. 62/263,606, filed Dec. 4, 2015, entitled SYSTEM AND METHOD FOR OBJECT DETECTION DATASET APPLICATION DEEP-LEARNING ALGORITHM TRAINING, the contents of which are hereby incorporated by reference.

### TECHNICAL FIELD

The present disclosure relates generally to machine learning algorithms, and more specifically to enhancement of neural network datasets.

### BACKGROUND

Systems have attempted to use various neural networks and computer learning algorithms to identify objects of interest within an image or a series of images. However, existing attempts to train such neural networks typically require large datasets of ten in the range of thousands of images, with the objects of interests labeled by hand for all the instances of the objects of interest within all the images. Such a labelling process can be very tedious and labor-intensive. Thus, there is a need for an improved method for generating large datasets for training neural networks for object detection, using a relatively small set of images.

### SUMMARY

The following presents a simplified summary of the disclosure in order to provide a basic understanding of certain embodiments of the present disclosure. This summary is not an extensive overview of the disclosure and it does not identify key/critical elements of the present disclosure or delineate the scope of the present disclosure. Its sole purpose is to present some concepts disclosed herein in a simplified form as a prelude to the more detailed description that is presented later.

In general, certain embodiments of the present disclosure provide techniques or mechanisms for enhancement of neural network datasets. According to various embodiments, a method for neural network dataset enhancement is provided. The method comprises taking a first picture using a fixed camera of just a set background, then taking a second picture with the fixed camera. The second picture is taken with the set background and an object of interest in the picture frame.

The method further comprises extracting pixels of the image of the object of interest from the second picture. Extracting the pixels of the image of the object of interest may include comparing the first picture with the second picture and designating any different pixels as pixels of the image of the object of interest. A minimal bounding box around the object of interest may also be extracted when the pixels of the image of the object of interest are extracted. The minimal bounding box may be automatically generated from the extracted pixels of the image of the object of interest.

The method further comprises superimposing the pixels of the image of the object of interest onto a plurality of different images. The location of the placement of the object of interest during superimposing is chosen such that the location of the minimal bounding box surrounding the object of interest is immediately known without the need for labeling. The plurality of different images have varied lighting, backgrounds and other objects in the images.

The method may further include repeating the process with the object of interest at several different angles in order to get a varied perspective of the object of interest. The process is repeated such that a dataset is generated. The dataset may be sufficiently large to accurately train a neural network to recognize an object in an image. The neural network can be sufficiently trained with only 3-10 pictures of objects of interest actually taken with the fixed camera. The neural network may also be trained to draw minimal bounding boxes around objects of interest.

In another embodiment, a system for neural network dataset enhancement is provided. The system includes a fixed camera, a set background, one or more processors, memory, and one or more programs stored in the memory. The one or more programs comprise instructions to take a first picture using a fixed camera of just a set background, then take a second picture with the fixed camera. The second picture is taken with the set background and an object of interest in the picture frame. The one or more programs further comprise instructions to extract pixels of the image of the object of interest from the second picture, and superimpose the pixels of the image of the object of interest onto a plurality of different images.

In yet another embodiment, a non-transitory computer readable storage medium is provided. The computer readable storage medium stores one or more programs comprising instructions to take a first picture using a fixed camera of just a set background, then take a second picture with the fixed camera. The second picture is taken with the set background and an object of interest in the picture frame. The one or more programs further comprise instructions to extract pixels of the image of the object of interest from the second picture, and superimpose the pixels of the image of the object of interest onto a plurality of different images.

These and other embodiments are described further below with reference to the figures.

### BRIEF DESCRIPTION OF THE DRAWINGS

The disclosure may best be understood by reference to the following description taken in conjunction with the accompanying drawings, which illustrate particular embodiments of the present disclosure.

FIG. 1 illustrates a particular example of a system for enhancing object detection datasets with minimal labeling and input, in accordance with one or more embodiments.

FIGS. 2A, 2B, and 2C illustrate an example of a method for neural network dataset enhancement, in accordance with one or more embodiments.

FIG. 3 illustrates one example of a neural network system that can be used in conjunction with the techniques and mechanisms of the present disclosure in accordance with one or more embodiments.

### DETAILED DESCRIPTION OF PARTICULAR EMBODIMENTS

Reference will now be made in detail to some specific examples of the present disclosure including the best modes contemplated by the inventors for carrying out the present disclosure. Examples of these specific embodiments are illustrated in the accompanying drawings. While the present disclosure is described in conjunction with these specific embodiments, it will be understood that it is not intended to limit the present disclosure to the described embodiments. On the contrary, it is intended to cover alternatives, modifications, and equivalents as may be included within the spirit and scope of the present disclosure as defined by the appended claims.

For example, the techniques of the present disclosure will be described in the context of particular algorithms. However, it should be noted that the techniques of the present disclosure apply to various other algorithms. In the following description, numerous specific details are set forth in order to provide a thorough understanding of the present disclosure. Particular example embodiments of the present disclosure may be implemented without some or all of these specific details. In other instances, well known process operations have not been described in detail in order not to unnecessarily obscure the present disclosure.

Various techniques and mechanisms of the present disclosure will sometimes be described in singular form for clarity. However, it should be noted that some embodiments include multiple iterations of a technique or multiple instantiations of a mechanism unless noted otherwise. For example, a system uses a processor in a variety of contexts. However, it will be appreciated that a system can use multiple processors while remaining within the scope of the present disclosure unless otherwise noted. Furthermore, the techniques and mechanisms of the present disclosure will sometimes describe a connection between two entities. It should be noted that a connection between two entities does not necessarily mean a direct, unimpeded connection, as a variety of other entities may reside between the two entities. For example, a processor may be connected to memory, but it will be appreciated that a variety of bridges and controllers may reside between the processor and memory. Consequently, a connection does not necessarily mean a direct, unimpeded connection unless otherwise noted.

### Overview

According to various embodiments, a method for neural network dataset enhancement is provided. The method comprises taking a first picture using a fixed camera of just a set background, then taking a second picture with the fixed camera. The second picture is taken with the set background and an object of interest in the picture frame. The method further comprises extracting pixels of the image of the object of interest from the second picture, and superimposing the pixels of the image of the object of interest onto a plurality of different images.

Thus, each picture of an object of interest may be converted into any number of training images used to train one or more neural networks for object recognition, detection, and/or tracking of such object of interest. In various embodiments, such methods may be used to train object recognition and/or detection may be performed by a neural network detection system as described in the U.S. Patent Application titled SYSTEM AND METHOD FOR IMPROVED GENERAL OBJECT DETECTION USING NEURAL NETWORKS filed on Nov. 30, 2016 which claims priority to

U.S. Provisional Application No. 62/261,260, filed Nov. 30, 2015, of the same title, each of which are hereby incorporated by reference. Tracking of objects of interest through multiple image frames may be performed by a tracking system as described in the U.S. Patent Application entitled SYSTEM AND METHOD FOR DEEP-LEARNING BASED OBJECT TRACKING filed on Dec. 2, 2016 which claims priority to U.S. Provisional Application No. 62/263,611, filed on Dec. 4, 2015, of the same title, each of which are hereby incorporated by reference.

As a result, existing computer functions are improved because fewer images, containing the objects of interest, need to be captured and stored. Additionally, images containing superimposed pixels of the image of the object of interest may be generated on the fly as the neural networks are trained. This further reduces required image data storage for the systems described herein.

### Example Embodiments

In various embodiments, a system and method for generating large datasets for training neural networks for object detection, using a relatively small set of easy-to-obtain images is presented. Such a system would allow for training a neural network (or some other type of algorithm which requires a large, labeled dataset) to detect an object of interest, using a small number of photos of the object of interest. This ability may greatly ease the process of building an algorithm for detecting a new object of interest.

Various algorithms “detect” objects by specifying (in pixel coordinates) a minimum bounding box around the object of interest, parameterized by the center of the box as well as the height and width of the box. Such algorithms typically require large datasets of ten in the range of thousands of images, with the bounding boxes drawn by hand for all the instances of the object of interest within all the images. Such a labelling process can be very tedious and labor-intensive. In some embodiments, the disclosed system and method greatly reduces the labor required to build such a dataset, requiring only a few images of the object of interest, along with a large number of varied objects and background, which can easily be downloaded or obtained from the interne or other database. In addition, the disclosed system and method actually improve the efficiency and resource management of computers and computer systems themselves because only a limited amount of an input dataset need to be initially processed.

Furthermore, in various embodiments, gesture recognition for user interaction may also be implemented in conjunction with methods and systems described herein. For example, objects of interest may include fingers, hands, arms, and/or faces of one or more users. By using the methods and systems described herein to train neural networks to detect and track such objects of interest, such systems may be implemented to allow users to interact in virtual reality (VR) and/or augmented reality (AR) environments. In various embodiments, gesture recognition may be performed by a gesture recognition neural network as described in the U.S. Patent Application entitled SYSTEM AND METHOD FOR IMPROVED GESTURE RECOGNITION USING NEURAL NETWORKS filed on Dec. 5, 2016 which claims priority to U.S. Provisional Application No. 62/263,600, entitled U.S. Patent Application entitled SYSTEM AND METHOD IMPROVED GESTURE RECOGNITION USING NEURAL NETWORKS, filed on Dec. 4, 2015, each of which are hereby incorporated by reference. In various embodiments, user interaction may be implemented by an interaction neural network as described in the U.S. Patent Application entitled SYSTEM AND METHOD FOR IMPROVED VIRTUAL REALITY USER INTERACTION UTILIZING DEEP-LEARNING filed on Dec. 5, 2016 which claims priority to U.S. Provisional Application No. 62/263,607, filed on Dec. 4, 2015, of the same title, each of which are hereby incorporated by reference.

### Input Data and Background Subtraction

The system generates a large number of training images for object detection by performing two steps. In some embodiments, the first step is to extract the object of interest from the few images of the object of interest which are required by the system. In various embodiments, extraction of the object of interest may be done by image subtraction. To perform the image subtraction, we first require an image that contains exactly the background/setting which will be used for the image that contains the object of interest, but with the object of interest removed. For example, suppose the object of interest is a coffee mug, and that the setting for taking the images is a table. First, the camera is fixed in a fixed position. Then, a first picture is taken without the coffee mug in the frame to create a “background image.” Next, a second picture is taken with the object of interest in the frame to create an “object image.”

To generate large amounts of data, the pixels of the object image that contain the object of interest need to be extracted first. In some embodiments the background image is compared with the object image, and any pixel which is different between the two is taken to be part of the object of interest. This set of pixels, which correspond to the object of interest are then extracted. From the set of pixels, a minimal bounding box surrounding the object of interest is also extracted. In some embodiments, the extraction process repeated by taking photos of the object of interest from varying angles to obtain a varied perspective of the object.

### Data Generation

Given the set of pixels which compose the object of interest, the pixels are then superimposed onto random images which include varied image settings, such as lighting, backgrounds, other objects, etc. The purpose of this is to train the neural network in a varied number of settings. The neural network will then be able to generalize and learn to detect the object in a large number of image settings.

In various embodiments, one or more parameters are varied when the pixels corresponding to the object of interest are superimposed onto the random images, in order to make the dataset as broad as possible. In some embodiments, such parameters may include the relative size of the object (compared to the image it is being superimposed onto), the number of times the object appears within the image and the locations of the objects within the image, the rotation of the object, and the contrast of the object. In some embodiments, applying all these permutations, combined with a large number of miscellaneous background images, can yield a dataset of innumerable different possible final images. Because the placement of the object of interest within the image is known (which may be in multiple locations), the location of the bounding box within the image is immediately identified by the neural network, and thus no labeling is required. As previously described, existing computer functions are improved because fewer images, containing the objects of interest, need to be captured and stored. Only several images of an object of interest, from various angles, may be needed to yield a dataset containing innumerable different possible final images.

### Usage within Detection Algorithm Training

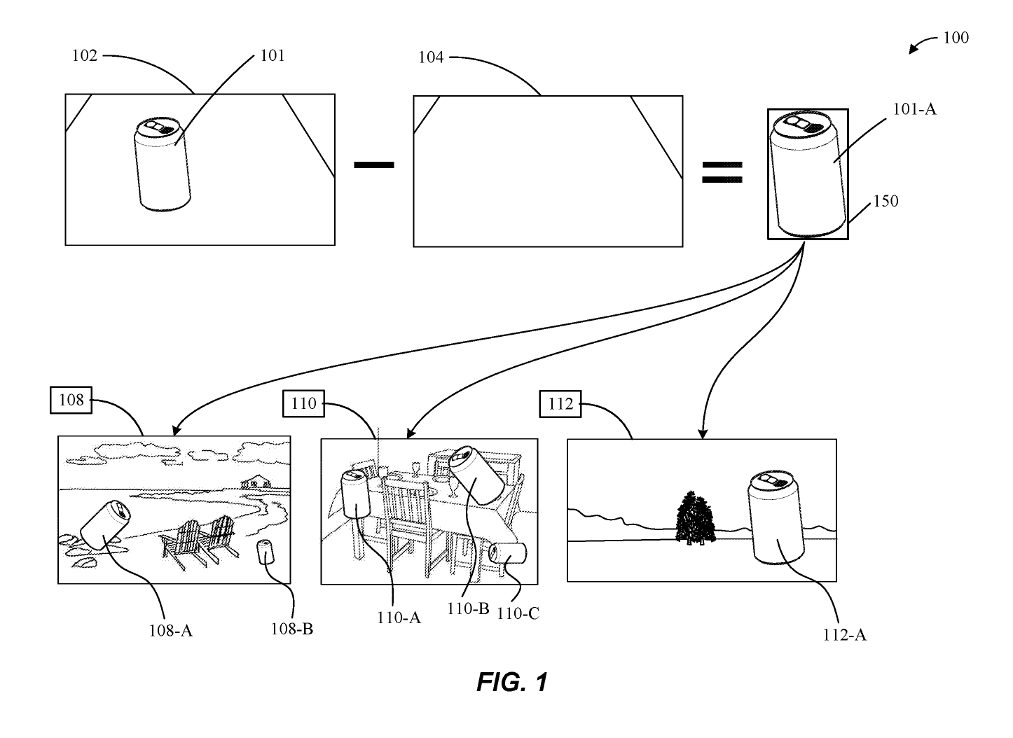

Using the above techniques, a large dataset for training object detection systems may be created. Such methods may be used to develop object detection systems for a large variety of objects, using only a few photos. Although the number of different perspectives and images of the object of interest may vary, typically sufficient accuracy can be obtained by using a dataset generated from between three to 10 images of the object, along with approximately 10,000 different unlabeled background images, which may be downloaded or obtained from the internet or other database. As previously described, the dataset may be generated on the fly as the neural networks are trained. This further reduces required image data storage for the systems described herein, which additionally improves computer functioning. Overall, neural network computer system functioning is improved because the methods and systems described herein accelerate the ability of the computer to be trained. FIG. 1 illustrates a particular example of a system 100 for enhancing object detection datasets with minimal labeling and input, in accordance with one or more embodiments. The object of interest depicted in FIG. 1 is soda can 101. To generate the dataset for the can 101, system 100 may require two input images 102 and 104. The first input image 102 contains can 101. The second image 104 is identical to the first image, except that can 101 is removed. Performing an image subtraction between the first image 102 and the second image 104 yields the pixels 101-A which correspond to the object of interest, can 101. A minimal bounding box 150 may also be extracted along with pixels 101-A in some embodiments. For purposes of illustration, box 150 may not be drawn to scale. Thus, although box 150 may represent smallest possible bounding boxes, for practical illustrative purposes, it is not literally depicted as such in FIG. 1. In some embodiments, the borders of the bounding boxes are only a single pixel in thickness and are only thickened and enhanced, as with box 150, when the bounding boxes have to be rendered in a display to a user, as shown in FIG. 1.

Once pixels 101-A have been extracted, the object of interest (can 101) can be superimposed onto other miscellaneous images which can easily be extracted from the interne (e.g. Google Images) or any other collection of images. FIG. 1 shows the object of interest (can 101) being superimposed onto a background image 108 in two instances, at 108-A and 108-B, within the image 108. The first instance 108-A has can 101 rotated slightly from its original orientation. The second instance 108-B has can 101 reduced in size. The second background image 110 has the object of interest (can 101) superimposed three times. The first time, at 110-A, can 101 is placed randomly within image 110. In the second instance, at 110-B, can 101 is rotated and resized to be larger and placed elsewhere within the image 110. Finally, can 101 is rotated even more and enlarged at 110-C and placed towards the bottom of the image. The final example shows a third background image 112, with another instance of can 101 enlarged and placed at 112-A of the background image 112.

Although the images 108, 110, and 112 are shown in FIG. 1 as black and white line drawings, actual images generated may include color and/or other details, which may be relevant for the training of various neural networks.

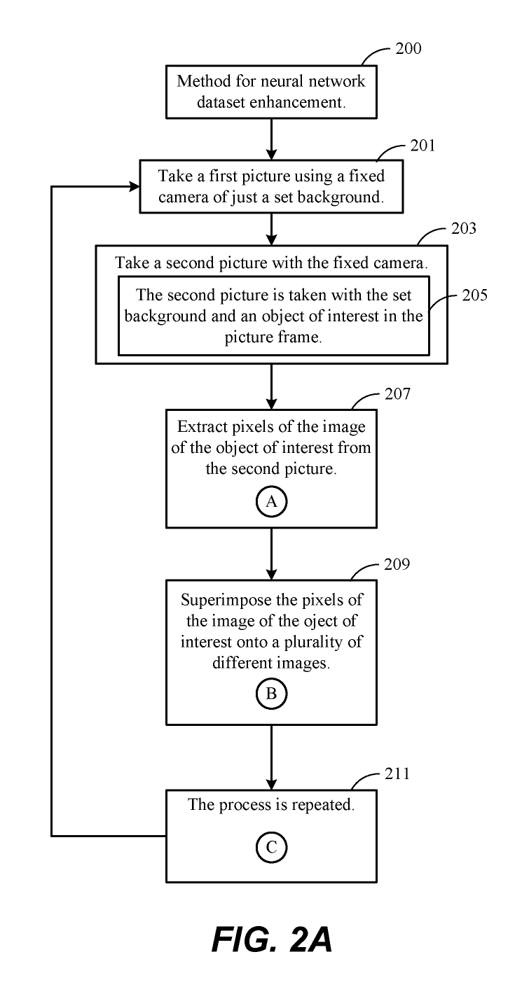

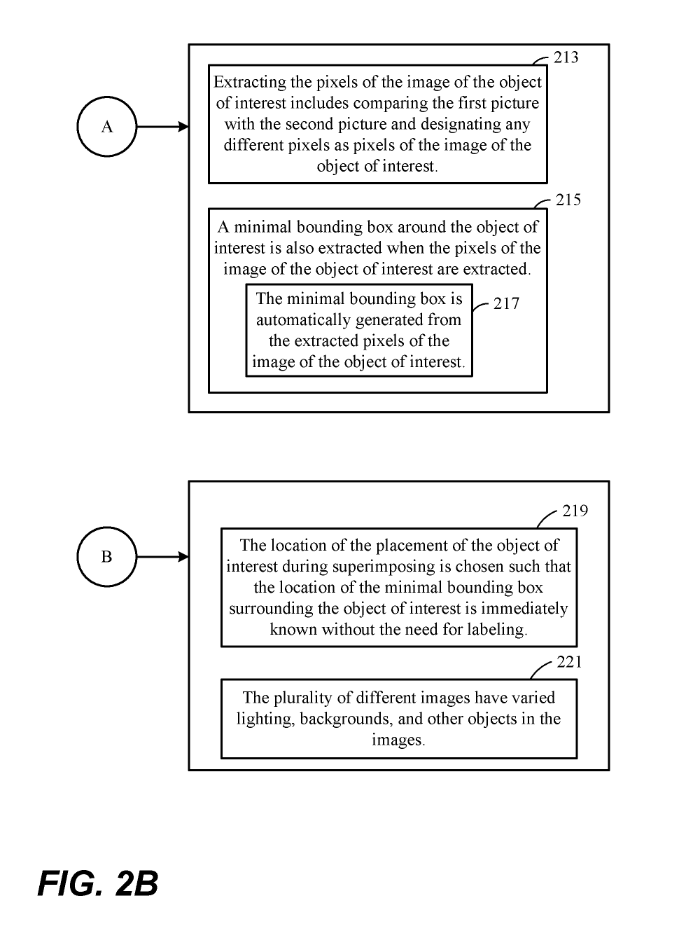

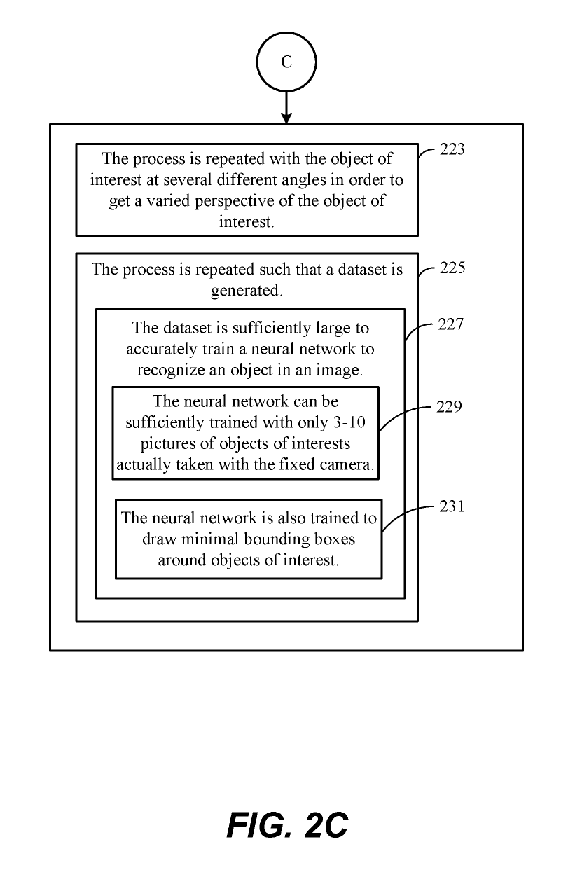

FIGS. 2A, 2B, and 2C illustrate an example of a method 200 for neural network dataset enhancement, in accordance with one or more embodiments. At 201, a fixed camera is used to take a first picture of just a set background. At 203, the fixed camera is used to take a second picture. In some embodiments, the second picture is taken with the set with the set background and an object of interest 205 in the picture frame. At 207, pixels of the image of the object of interest 205 are extracted from the second picture. In some embodiments, extracting the pixels of the image of the object of interest 205 includes comparing 213 the first picture with the second picture and designating any different pixels as pixels of the image of the object of interest 205, such as described with reference to pixels 101-A in FIG. 1. In some embodiments, a minimal bounding box 215 around the object of interest is also extracted when the pixels of the image of the object of interest 205 are extracted, such as bounding box 150. In further embodiments, the minimal bounding box 215 is automatically generated 217 from the extracted pixels of the image of the object of interest 205.

At 209, the pixels of the image of the object of interest 205 is superimposed onto a plurality of different images 221, such as in images 108, 110, and 112. In some embodiments, the location 219 of the placement of the object of interest 205 during superimposing is chosen such that the location of the minimal bounding box 215 surrounding the object of interest 205 is immediately known without the need for labeling. In other embodiments, the placement and/or rotation of the object of interest 205 during superimposing is chosen at random.

In other embodiments, the plurality of different images 221 have varied lighting, backgrounds, and other objects in the images. For example, image 108 depicts a coast with a body of water and a set of chairs along the shore line, as well as a house in the background. Image 110 depicts a dining table set with glasses and plates, as well as four chairs. Image 1120 depicts scenery with mountains and two trees. In various embodiments, any number of different images 221 may be selected from a database of images. In some embodiments, such different images 221 may be selected at random. In some embodiments the database may be a global database accessed via a network.

The process is repeated at step 211. In some embodiments, the process is repeated with the object of interest 205 at several different angles 223 in order to get a varied perspective of the object of interest. In other embodiments, the process is repeated such that a dataset 225 is generated. In some embodiments, the dataset 225 is sufficiently large to accurately train 229 a neural network 227 to recognize an object in an image. In some embodiments, such neural network 227 may be a neural network detection system as described in the U.S. Patent Application titled SYSTEM AND METHOD FOR IMPROVED GENERAL OBJECT DETECTION USING NEURAL NETWORKS, previously referenced above. In some embodiments, the neural network 227 can be sufficiently trained 229 with only 3 to 10 pictures of objects of interests 205 actually taken with fixed camera. In various embodiments, the neural network 227 is also trained to draw (231) minimal bounding boxes 215 around objects of interest 205.

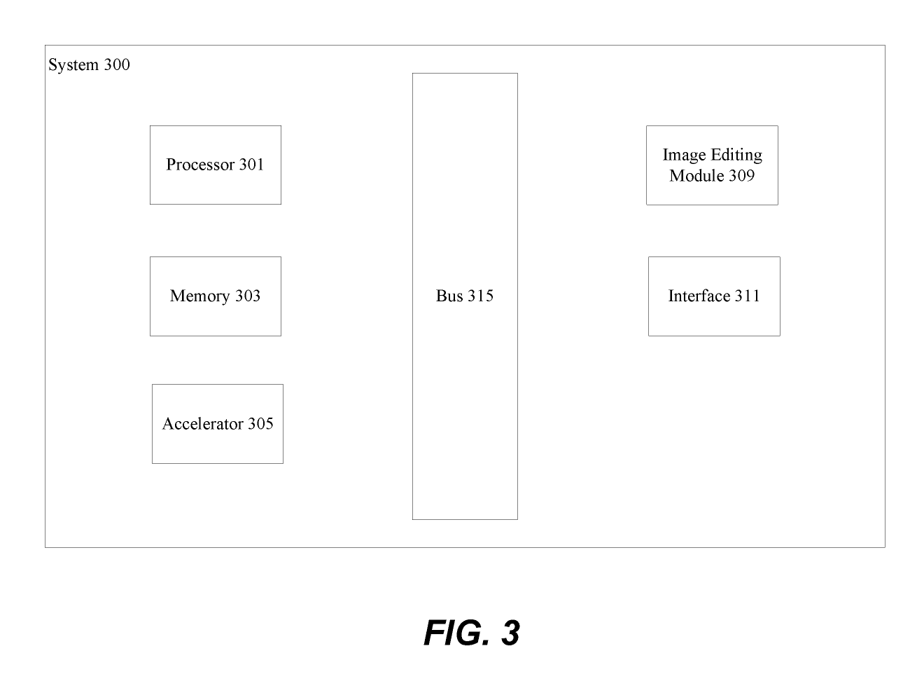

FIG. 3 illustrates one example of a neural network system 300, in accordance with one or more embodiments. According to particular embodiments, a system 300, suitable for implementing particular embodiments of the present disclosure, includes a processor 301, a memory 303, accelerator 305, image editing module 309, an interface 311, and a bus 315 (e.g., a PCI bus or other interconnection fabric) and operates as a streaming server. In some embodiments, when acting under the control of appropriate software or firmware, the processor 301 is responsible for various processes, including processing inputs through various computational layers and algorithms. Various specially configured devices can also be used in place of a processor 301 or in addition to processor 301. The interface 311 is typically configured to send and receive data packets or data segments over a network.

Particular examples of interfaces supports include Ethernet interfaces, frame relay interfaces, cable interfaces, DSL interfaces, token ring interfaces, and the like. In addition, various very high-speed interfaces may be provided such as fast Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control such communications intensive tasks as packet switching, media control and management.

According to particular example embodiments, the system 300 uses memory 303 to store data and program instructions for operations including training a neural network, object detection by a neural network, and distance and velocity estimation. The program instructions may control the operation of an operating system and/or one or more applications, for example. The memory or memories may also be configured to store received metadata and batch requested metadata.

In some embodiments, system 300 further comprises an image editing module 309 configured for comparing images, extracting pixels, and superimposing pixels on background images, as previously described with reference to method 200 in FIGS. 2A-2C. Such image editing module 309 may be used in conjunction with accelerator 305. In various embodiments, accelerator 305 is a rendering accelerator chip. The core of accelerator 305 architecture may be a hybrid design employing fixed-function units where the operations are very well defined and programmable units where flexibility is needed. Accelerator 305 may also include of a binning subsystem and a fragment shader targeted specifically at high level language support. In various embodiments, accelerator 305 may be configured to accommodate higher performance and extensions in APIs, particularly OpenGL 2 and DX9.

Because such information and program instructions may be employed to implement the systems/methods described herein, the present disclosure relates to tangible, or non-transitory, machine readable media that include program instructions, state information, etc. for performing various operations described herein. Examples of machine-readable media include hard disks, floppy disks, magnetic tape, optical media such as CD-ROM disks and DVDs; magneto-optical media such as optical disks, and hardware devices that are specially configured to store and perform program instructions, such as read-only memory devices (ROM) and programmable read-only memory devices (PROMs). Examples of program instructions include both machine code, such as produced by a compiler, and files containing higher level code that may be executed by the computer using an interpreter.

While the present disclosure has been particularly shown and described with reference to specific embodiments thereof, it will be understood by those skilled in the art that changes in the form and details of the disclosed embodiments may be made without departing from the spirit or scope of the present disclosure. It is therefore intended that the present disclosure be interpreted to include all variations and equivalents that fall within the true spirit and scope of the present disclosure. Although many of the components and processes are described above in the singular for convenience, it will be appreciated by one of skill in the art that multiple components and repeated processes can also be used to practice the techniques of the present disclosure.

What is claimed is:

1. A method for neural network dataset enhancement, the method comprising:
taking a first picture using a fixed camera of just a set background;
taking a second picture with the fixed camera, the second picture being taken with the set background and an object of interest in the picture frame;
extracting pixels of the image of the object of interest from the second picture; and
superimposing the pixels of the image of the object of interest onto a plurality of different images.

2. The method of claim 1, wherein extracting the pixels of the image of the object of interest includes comparing the first picture with the second picture and designating any differing pixels as pixels of the image of the object of interest.

3. The method of claim 1, wherein a minimal bounding box around the object of interest is also extracted when the pixels of the image of the object of interest are extracted.

4. The method of claim 3, wherein the minimal bounding box is automatically generated from the extracted pixels of the image of the object of interest.

5. The method of claim 3, wherein the location of the placement of the object of interest during superimposing is chosen such that the location of the minimal bounding box surrounding the object of interest is immediately known without the need for labeling.

6. The method of claim 1, wherein the process is repeated with the object of interest at several different angles in order to get a varied perspective of the object of interest.

7. The method of claim 1, wherein the images in the plurality of different images have varied lighting, backgrounds, and other objects in the images.

8. The method of claim 1, wherein the process is repeated such that a dataset is generated, the dataset being sufficiently large to accurately train a neural network to recognize an object in an image.

9. The method of claim 7, wherein the neural network can be sufficiently trained with only 3-10 pictures of objects of interests actually taken with the fixed camera.

10. The method of claim 7, wherein the neural network is also trained to draw minimal bounding boxes around objects of interest.

11. A system for neural network dataset enhancement, comprising:
a fixed camera;
a set background;
one or more processors;
memory; and
one or more programs stored in the memory, the one or more programs comprising instructions for:
taking a first picture using the fixed camera of just the set background;
taking a second picture with the fixed camera, the second picture being taken with the set background and an object of interest in the picture frame;
extracting pixels of the image of the object of interest from the second picture; and
superimposing the pixels of the image of the object of interest onto a plurality of different images.

12. The system of claim 11, wherein extracting the pixels of the image of the object of interest includes comparing the first picture with the second picture and designating any differing pixels as pixels of the image of the object of interest.

13. The system of claim 11, wherein a minimal bounding box around the object of interest is also extracted when the pixels of the image of the object of interest are extracted.

14. The system of claim 13, wherein the minimal bounding box is automatically generated from the extracted pixels of the image of the object of interest.

15. The system of claim 13, wherein the location of the placement of the object of interest during superimposing is chosen such that the location of the minimal bounding box surrounding the object of interest is immediately known without the need for labeling.

16. The system of claim 11, wherein the process is repeated with the object of interest at several different angles in order to get a varied perspective of the object of interest.

17. The system of claim 11, wherein the images in the plurality of different images have varied lighting, backgrounds, and other objects in the images.

18. The system of claim 11, wherein the process is repeated such that a dataset is generated, the dataset being sufficiently large to accurately train a neural network to recognize an object in an image.

19. The system of claim 17, wherein the neural network is also trained to draw minimal bounding boxes around objects of interest.

20. A non-transitory computer readable storage medium storing one or more programs configured for execution by a computer, the one or more programs comprising instructions for:
taking a first picture using a fixed camera of just a set background;
taking a second picture with the fixed camera, the second picture being taken with the set background and an object of interest in the picture frame;
extracting pixels of the image of the object of interest from the second picture;
and superimposing the pixels of the image of the object of interest onto a plurality of different images.
